(19) United States
(12) Patent Application Publication
(10) Pub. No.: US 2014/0284515 A1
(43) Pub. Date: Sep. 25, 2014

(54) FERRITE THIN FILM-FORMING COMPOSITION AND METHOD OF FORMING FERRITE THIN FILM

(71) Applicant: MITSUBISHI MATERIALS CORPORATION, Tokyo (JP)

(72) Inventors: Toshihiro Doi, Naka-gun (JP); Hideaki Sakurai, Naka-gun (JP); Nobuyuki Soyama, Naka-gun (JP); Kenzo Nakamura, Naka-gun (JP); Kazunori Igarashi, Kitamoto-shi (JP)

(73) Assignee: MITSUBISHI MATERIALS CORPORATION, Tokyo (JP)

(21) Appl. No.: 14/181,171

(22) Filed: Feb. 14, 2014

(30) Foreign Application Priority Data
Mar. 25, 2013 (JP) 2013-061609

(51) Int. Cl. H01F 1/01; H01F 41/24

(52) U.S. Cl. CPC H01F 1/01; H01F 41/24
USPC 252/62.56; 427/128

(57) ABSTRACT

This ferrite thin film-forming composition is a composition for forming a thin film of NiZn ferrite, CuZn ferrite, or NiCuZn ferrite using a sol-gel method, and the composition includes: metal raw materials; and a solvent containing N-methyl pyrrolidone, wherein a ratio of an amount of N-methyl pyrrolidone to 100 mass % of the total amount of the composition is in a range of 30 to 60 mass %.

### BACKGROUND OF THE INVENTION

1. Field of the Invention

The present invention relates to a ferrite thin film-forming composition for forming a magnetic film or the like of a thin film inductor, which is incorporated into an integrated passive device (IPD) chip, using a sol-gel method; and a method of forming a ferrite thin film using this composition.

The present application claims priority on Japanese Patent Application No. 2013-061609 filed on Mar. 25, 2013, the content of which is incorporated herein by reference.

2. Description of Related Art

Recently, demand for reducing the size and the weight of various electronic devices has rapidly increased, and demand for reducing the size and the thickness of a capacitor, an inductor, or the like has also increased, and the capacitor, the inductor, or the like is incorporated into an IPD chip in which multiple passive elements are formed on a substrate. In order to reduce the thickness of an inductor, various types of inductors are disclosed, for example, a conventional wire-wound inductor having a structure in which a wire is wound around a bulk magnetic material; or a thin film inductor having a structure in which a spiral planar coil is interposed between magnetic materials such as ferrite.

As the magnetic materials used for an inductor, typically, a ferrite thin film or the like formed of a ferrite-based material is widely used in the related art, for example, because magnetic permeability is high in a high-frequency region. As a method of forming a ferrite thin film, film forming methods, such as a sputtering method or a chemical vapor deposition method, which require a vacuum process, have been mainly studied and developed. However, in these methods, it is necessary that an expensive device be used, and thus there is a cost problem in that, for example, the initial cost increases. Meanwhile, film forming methods such as a spin spray method to which electroless plating is applied have been studied. However, in this spin spray method, although there is an advantageous effect in that a ferrite film can be formed using a relatively inexpensive device, there is an environmental problem because a solution containing a large amount of raw materials is used during film formation.

In addition to a spin spray method, a sol-gel method has attracted attention as a method of forming a ferrite thin film which can be used instead of a sputtering method In a sol-gel method, unlike a sputtering method, a vacuum process is not required, and a film can be formed at a low cost through relatively simple processes such as preparing, coating, drying, and baking processes of a composition. As a method of forming a ferrite thin film using a sol-gel method, Journal of Magnetism and Magnetic Materials, 309 (2007) pages 75 to 79 (2. Experimental on pages 75 to 76) discloses a method of forming a NiCuZn ferrite thin film, and the method includes: coating a mixed solution, which contains iron nitrate, nickel nitrate, dimethyl formamide, zinc acetate, and copper nitrate, on a Si substrate on which SiO₂ is formed using a spin coating method to form a coating film thereon; drying the coating film at 120° C. for 10 minutes to remove a solvent; and heating the coating film at 400° C. for 30 minutes to be thermally decomposed.

In addition, Published Japanese Translation No. 2001-521976 of the PCT International Publication (paragraph [0188]) discloses that N-methyl pyrrolidone is used as a solvent of an ink composition for ink jet printing which is obtained by dispersing a core-shell polymer binder and ferrite powder.

### SUMMARY OF THE INVENTION

### Problems to be Solved by the Invention

However, in the above-described method disclosed in Journal of Magnetism and Magnetic Materials, 309 (2007) pages 75 to 79 (2. Experimental on pages 75 to 76), a mixed solution containing a formamide-based solvent as a solvent is used as a composition for forming a ferrite thin film. In a film formed using this composition (mixed solution), there is a problem in that it is difficult to further improve properties such as magnetic permeability. This problem is caused by a solvent or the like to be used, and one of the reasons is presumed to be as follows. It is difficult to further improve coating properties, film thickness uniformity, and the like when a solution is coated using, for example, a spin coating method. As a result, further improvement in the film density of the formed thin film cannot be expected any more.

In addition, with regard to the above-described composition disclosed in Journal of Magnetism and Magnetic Materials, 309 (2007) pages 75 to 79 (2. Experimental on pages 75 to 76), long-term storage stability deteriorates, and liquid precipitation is likely to occur over time. As a result, there is a problem in that coating film formability deteriorates. Therefore, when a ferrite thin film is formed using a sol-gel method, further improvement in coating film formability or the like is required from the viewpoint of improving a material. Therefore, the development of a ferrite thin film-forming composition has been desired which is capable of preventing precipitates from being formed even after long-term storage and maintaining superior coating film formability for a long term.

The composition disclosed in Published Japanese Translation No. 2001-521976 of the PCT International Publication (paragraph [0188]) is a composition for ink jet printing, and fastness to smear resistance is improved by the core-shell polymer binder. That is, the configuration and the object of the composition disclosed in Published Japanese Translation No. 2001-521976 of the PCT International Publication are completely different from those of a composition according to the invention described below. Further, the composition disclosed in Published Japanese Translation No. 2001-521976 of the PCT International Publication is a composition formed of a dispersion obtained by dispersing ferrite powder in a solvent, and the configuration thereof is completely different from that of a composition formed of a sol according to the invention in which a metal alkoxide and the like are used as raw materials.

An object of the invention is to provide a ferrite thin film-forming composition for forming a ferrite thin film using a sol-gel method, the composition being capable of forming a ferrite thin film having a thin and uniform thickness and obtaining superior long-term storage stability; and a method of forming a ferrite thin film using this composition.

### Means for Solving the Problems

According to a first aspect of the invention, a ferrite thin film-forming composition is provided for forming a ferrite thin film having a composition, which is represented by (Ni₁₋ₓZnₓO)ₜ(Fe₂O₃)ₜ, (Cu₁₋ₓZnₓO)ₜ(Fe₂O₃)ₛ, or (Ni_{0.80-y}Cu_{0.20}Zn_{y}O)ₜ(Fe₂O₃)ₛ, using a sol-gel method.

The composition contains: metal raw materials: and a solvent containing N-methyl pyrrolidone, wherein a ratio of an amount of N-methyl pyrrolidone to 100 mass % of the total amount of the composition is in a range of 30 to 60 mass %.

In the above formula, x satisfies 0<x<1; y satisfies 0<y<0.80; and s and t satisfy 0.95≦s≦1.05 and 0.95≦t≦1.05, respectively, and s and t also satisfy s+t=2.

According to a second aspect of the invention, in the ferrite thin film-forming composition according to the first aspect, the metal raw materials may be metal alkoxides, acetates, naphthanates, or nitrates which include Ni, Zn, Cu, or Fe.

According to a third aspect of the invention, in the ferrite thin film-forming composition according to the first or second aspect, in the ferrite thin film having the composition represented by (Ni₁₋ₓZnₓO)ₜ(Fe₂O₃)ₛ, x may be in a range of 0.10≦x≦0.65.

According to a fourth aspect of the invention, in the ferrite thin film-forming composition according to the first or second aspect, in the ferrite thin film having the composition represented by (Cu₁₋ₓZnₓO)ₜ(Fe₂O₃)ₛ, x may be in a range of 0.20≦x≦0.80.

According to a fifth aspect of the invention, in the ferrite thin film-forming composition according to the first or second aspect, in the ferrite thin film having the composition represented by (Ni_{0.80-y}Cu_{0.20}Zn_{y}O)ₜ(Fe₂O₃)ₛ, y may be in a range of 0.20≦x≦0.40.

According to a sixth aspect of the invention, a method of forming a ferrite thin film is provided, the method includes forming a film with a sol-gel method using the ferrite thin film-forming composition according to any one of the first to fifth aspects.

### Effects of the Invention

The ferrite thin film-forming composition according to the first aspect is a composition for forming a thin film of NiZn ferrite, CuZn ferrite, or NiCuZn ferrite using a sol-gel method, and the composition includes: metal raw materials; and a solvent containing N-methyl pyrrolidone, wherein a ratio of an amount of N-methyl pyrrolidone to 100 mass % of the total amount of the composition is in a range of 30 to 60 mass %. As described above, since the ferrite thin film-forming composition according to the invention contains N-methyl pyrrolidone as a solvent at a predetermined ratio, a stable compound is formed with a dissolved iron precursor; and thereby, precipitation is suppressed. Accordingly, the ferrite thin film-forming composition according to the first aspect is superior in the coating film formability during film formation and the storage stability of the composition, as compared to a composition of the related art which is formed using a formamide-based solvent.

In the ferrite thin film-forming composition according to the second aspect, metal alkoxides, acetates, naphthanates, or nitrates which include Ni, Zn, Cu, or Fe are used as the metal raw materials. As a result, the storage stability of the composition can be further improved.

In the ferrite thin film-forming composition according to the third aspect, in the ferrite thin film having the composition represented by (Ni₁₋ₓZnₓO)ₜ(Fe₂O₃)ₛ, x is in a range of 0.10≦x≦0.65. As a result, the magnetic permeability of the formed thin film is increased, and the iron loss of the film is reduced.

In the ferrite thin film-forming composition according to the fourth aspect, in the ferrite thin film having the composition represented by (Cu₁₋ₓZnₓO)ₜ(Fe₂O₃)ₛ, x is in a range of 0.20≦x≦0.80. As a result, the magnetic permeability of the formed thin film is increased, and the iron loss of the film is reduced.

In the ferrite thin film-forming composition according to the fifth aspect, in the ferrite thin film having the composition represented by (Ni_{0.80-y}Cu_{0.20}Zn_{y}O)ₜ(Fe₂O₃)ₛ, y is in a range of 0.20≦x≦0.40. As a result, the magnetic permeability of the formed thin film is increased, and the iron loss of the film is reduced.

In the method of forming a ferrite thin film according to the sixth aspect, since the above-described ferrite thin film-forming composition according to the invention is used, the composition can be uniformly coated on the entire surface of a substrate without spots, and a uniform thin film can be formed. In addition, in this method, since a thin film is formed with a sol-gel method with the above-described composition, a vacuum process such as CVD is not required, and a thin film can be easily formed at a low cost.

### DETAILED DESCRIPTION OF THE INVENTION

Next, embodiments of the invention will be described.

A ferrite thin film-forming composition according to the present embodiment is a composition for forming a ferrite thin film having a composition, which is represented by (Ni₁₋ₓZnₓO)ₜ(Fe₂O₃)ₛ, (Cu₁₋ₓZnₓO)ₜ(Fe₂O₃)ₛ, or (Ni_{0.80-y}Cu_{0.20}Zn_{y}O)ₜ(Fe₂O₃)ₛ, using a sol-gel method. This composition contains: metal raw materials; and a solvent containing N-methyl pyrrolidone. Specifically, the composition is obtained by dissolving the metal raw materials in the solvent containing N-methyl pyrrolidone. In addition, a ratio of an amount of N-methyl pyrrolidone to 100 mass % of the total amount of the composition is in a range of 30 to 60 mass %, and preferably in a range of 35 to 50 mass %. In the above formula, x satisfies 0<x<1; y satisfies 0<y<0.80, and s and t satisfy 0.95≦s≦1.05 and 0.95≦t≦1.05, respectively, and s and t also satisfy s+t=2.

The ferrite thin film-forming composition according to the embodiment has the above-described configuration; and therefore, the composition has extremely superior coating film formability during the formation of a ferrite thin film using a sol-gel method, as compared to a composition of the related art which is formed using a formamide-based solvent. Therefore, when this composition is used, the composition can be uniformly coated on the entire surface of a substrate using for example, a spin coating method, and thus a ferrite thin film having a thin and uniform thickness can be formed. Further, the ferrite thin film-forming composition according to the embodiment is superior in storage stability without liquid precipitation even after long-term storage.

The reason why the composition contains N-methyl pyrrolidone as a solvent is as follows. Since N-methyl pyrrolidone has high affinity to other solvents such as propylene glycol or ethanol, the coating film formability of the composition is improved as compared to a composition of the related art which is formed using a formamide-based solvent. Among solvents, N-methyl pyrrolidone is more preferably used. In addition, since N-methyl pyrrolidone has high affinity to precursor substances, the storage stability is improved without liquid precipitation even after long-term storage. Specifically, the precursor substances form a stable compound with an iron precursor dissolved in the composition; and thereby, precipitation is suppressed. In addition, the reason why the amount ratio of N-methyl pyrrolidone is limited to be in the above-described range is as follows. When the amount ratio of N-methyl pyrrolidone is lower than the lower limit, the storage stability deteriorates, and there is a problem in that liquid precipitation occurs. When the amount ratio is higher than the upper limit, the coating film formability deteriorates.

As a solvent, N-methyl pyrrolidone can be used in combination with other solvents including lower alcohols such as ethanol and diols such as propylene glycol. By using other solvents together with N-methyl pyrrolidone, the viscosity and the volatility of the solution can be adjusted. As other solvents, one kind or two or more kinds may be used.

A ratio of an amount of these other solvents to 100 mass % of the total amount of the composition may be in a range of 10 to 60 mass %.

The ferrite thin film-forming composition according to the embodiment is a composition for forming, particularly, a thin film of NiZn ferrite, CuZn ferrite, or NiCuZn ferrite among ferrite thin films, specifically, for forming a ferrite thin film having a composition which is represented by any one of the above-described three formulae: (Ni₁₋ₓZnₓO)ₜ(Fe₂O₃)ₛ, (Cu₁₋ₓZnₓO)ₜ(Fe₂O₃)ₛ, and (Ni_{0.80-y}Cu_{0.20}Zn_{y}O)ₜ(Fe₂O₃)ₛ. The metal raw materials are contained in the composition in such a manner that Ni, Zn, Cu, and Fe are included at ratios corresponding to the formula of the desired ferrite thin film.

In the ferrite thin film formed of the composition according to the embodiment, the reason why s and t should satisfy 0.95≦s≦1.05 and 0.95≦t≦1.05, respectively, and s and t should satisfy s+t=2 is as follows. When s and t are out of the above-described ranges, there is a problem in that the initial magnetic permeability and the resistance value of the formed thin film are decreased.

In addition, in the ferrite thin film having the composition represented by (Ni₁₋ₓZnₓO)ₜ(Fe₂O₃)ₛ, it is preferable that x be in a range of 0.10≦x≦0.65. When x is less than the lower limit or is more than the upper limit, the amount ratio of Ni to Zn is excessively low or excessively high. As a result, the initial magnetic permeability and the resistance value of the formed thin film are likely to be decreased.

In addition, in the ferrite thin film having the composition represented by (Cu₁₋ₓZnₓO)ₜ(Fe₂O₃)ₛ, it is preferable that x be in a range of 0.20≦x≦0.80. When x is less than the lower limit or is more than the upper limit, the amount ratio of Cu to Zn is excessively low or excessively high. As a result, the initial magnetic permeability and the resistance value of the formed thin film are likely to be decreased.

In addition, in the ferrite thin film having a composition represented by (Ni_{0.80-y}Cu_{0.20}Zn_{y}O)ₜ(Fe₂O₃)ₛ, it is preferable that y be in a range of 0.20≦y≦0.40. When y is less than the lower limit or is more than the upper limit, the amount ratio of Ni to Zn or Cu is excessively low or excessively high. As a result, the initial magnetic permeability and the resistance value of the formed thin film are likely to be decreased.

Examples of the metal raw materials which are contained in the composition at the ratios corresponding to the composition of the formed ferrite thin film include metal alkoxides, acetates, naphthanates, and nitrates which include Ni, Zn, Cu, or Fe. Specific examples of the metal raw materials include nickel (II) nitrate hexahydrate, zinc (II) nitrate tetrahydrate, copper (II) nitrate trihydrate, iron (III) nitrate nonahydrate, nickel (II) acetate tetrahydrate, zinc (II) acetate dihydrate, iron naphthenate, and iron (III) triethoxide. Among these, from the viewpoints of the storage stability of the composition, nitrates such as nickel (II) nitrate hexahydrate, zinc (II) nitrate tetrahydrate, copper (II) nitrate trihydrate, or iron (III) nitrate nonahydrate; and acetates such as nickel (II) acetate tetrahydrate are particularly preferable. The amount ratio of these metal materials is controlled in such a manner that the total amount of the metal materials in the composition becomes preferably in a range of 2 to 15 mass % and more preferably in a range of 5 to 7 mass % in terms of metal oxides.

“The amount ratio in terms of metal oxides” described herein refers to a value obtained by dividing a mass of the metal materials when all the metals become metal oxides by a mass of the whole composition.

In order to prepare the ferrite thin film-forming composition according to the embodiment, first, the above-described metal materials are prepared and weighted such that the ferrite thin film has the desired composition. In addition, N-methyl pyrrolidone is prepared at an amount in a range of 30 to 60 mass %, preferably in a range of 35 to 50 mass % with respect to 100 mass % of the prepared composition, and other solvents than N-methyl pyrrolidone are prepared at an amount in a range of, preferably 10 to 60 mass % with respect to 100 mass % of the prepared composition.

Next, the weighted metal materials are mixed with N-methyl pyrrolidone and other solvents. The mixture is stirred in an oil path or an ice bath, preferably, at a temperature of 0 to 30° C. for 0.5 to 24 hours to dissolve the metal materials in the solvents, and other solvents such as propylene glycol or n-butanol are further added thereto such that the total amount of the metal materials in the composition becomes preferably in a range of 2 to 15 mass % and more preferably in a range of 5 to 7 mass % in terms of metal oxides. The obtained solution is further stirred at room temperature for, preferably 2 to 24 hours. As a result, a ferrite thin film-forming composition according to the embodiment can be obtained.

Next, a method of forming a ferrite thin film using a sol-gel method according to the present embodiment of the invention will be described. First, the above-described ferrite thin film-forming composition according to the embodiment is coated on a substrate to form a coating film thereon. Preferable examples of the substrate for forming a ferrite thin film include a silicon substrate such as a Si/SiO₂ substrate and a heat resistant substrate such as an alumina substrate. Examples of a method of coating the ferrite thin film-forming composition on the substrate include a spin coating method, a dip coating method, and a liquid source misted chemical deposition (LSMCD) method. Among these, a spin coating method is particularly preferable from the viewpoint of obtaining high surface smoothness.

In addition, it is preferable that the coating amount of the composition be adjusted such that the thickness of the finally obtained ferrite thin film becomes in a range of 50 to 200 nm. The composition may be coated on the substrate by performing the coating process once. Alternatively, in order to prevent cracking, processes of coating, pre-baking under conditions described below, and additional coating may be performed multiple times, preferably, 2 to 20 times. In this case, it is preferable that the coating amount per each coating process be adjusted such that the thickness of a thin film formed per each coating process becomes in a range of 50 to 150 nm.

Next, a coating film which is formed on the substrate or a pre-baked film after pre-baking is pre-baked in the air or in an oxygen gas atmosphere under preferable conditions where a temperature is in a range of 100 to 450° C. and a holding time is in a range of 1 to 30 minutes, or more preferable conditions where a temperature is in a range of 400 to 450° C. and a holding time is in a range of 5 to 15 minutes. As a result, an amorphous pre-baked film is formed. The total thickness of the pre-baked films is preferably in a range of 90 to 3000 nm. In the process of pre-baking this coating film, a hot plate (HP), rapid thermal annealing (RTA), or the like is preferably used.

Finally, a ferrite thin film is obtained by baking the substrate on which the pre-baked films are formed. The substrate can be baked using rapid thermal annealing (RTA) and an electric furnace or a muffle furnace in the air or an oxygen gas atmosphere preferable conditions where a temperature is in a range of 500 to 800° C. and a holding time is in a range of 30 to 120 minutes, or more preferable conditions where a temperature is in a range of 700 to 800° C. and a holding time is in a range of 1 to 60 minutes.

Through the above-described processes, a ferrite thin film according to the embodiment can be formed. The ferrite thin film according to the embodiment is formed using the ferrite thin film-forming composition according to the embodiment, and therefore, the ferrite thin film is extremely thin and uniform and exhibits a desired magnetic permeability in a high-frequency region. Therefore, when this film is used as a magnetic material such as a magnetic film of a thin film inductor which is used in a high-frequency region, the size of the inductor can be reduced, and the properties thereof can be improved.

### EXAMPLES

Next, Examples of the invention and Comparative Examples will be described in detail.

### Example 1-1

First, nickel (II) nitrate hexahydrate, zinc (II) nitrate tetrahydrate, and iron (III) nitrate nonahydrate were prepared as the metal materials. These materials were weighed such that the composition of the formed ferrite thin film became (Ni_{0.64}Zn_{0.36}O)_{1.0}(Fe₂O₃)_{1.0}. In addition, as the solvent, N-methyl pyrrolidone was prepared in an amount of 30 mass % with respect to 100 mass % of the prepared composition. As other solvents, propylene glycol was prepared in an amount of 10 mass % with respect to 100 mass % of the prepared composition. These solvents were added to the metal materials, and then the mixture was stirred in an oil bath at a temperature of 30° C. for 6 hours.

After stirring, as other solvents, 37.2 mass % of butanol with respect to 100 mass % of the prepared composition was added to the solution such that the total amount of the metal materials in the composition became 5 mass % in terms of metal oxides. Next, the obtained solution was further stirred at room temperature for 24 hours. As a result, a ferrite thin film-forming composition was prepared.

Next, the prepared ferrite thin film-forming composition was subjected to spin coating at a rotating speed of 3000 rpm for 15 seconds. As a result, a coating film was formed on a silicon substrate on which a SiO₂ film was formed, and then the coating film was pre-baked at a temperature of 400° C. for 5 minutes. The processes from coating to pre-baking were repeated 5 times in total. As a result, an amorphous pre-baked film having the thickness shown in Table 1 was formed.

Finally, this film-formed substrate was baked at 700° C. by RTA. As a result, a NiZn ferrite thin film having the composition of (Ni_{0.64}Zn_{0.36}O)_{1.0}(Fe₂O₃)_{1.0}, and the thickness shown in Table 1 was formed.

### Examples 1-2 and 1-3 and Comparative Examples 1-1 and 1-2

Ferrite thin film-forming compositions were prepared in the same manner as Example 1-1, except that the ratio of an amount of N-methyl pyrrolidone to 100 mass % of the total amount of the prepared composition was adjusted to the value shown in Table 1 below. Using these ferrite thin-film-forming compositions, NiZn ferrite thin films having the thicknesses shown in Table 1 were formed.

### Examples 1-4 to 1-9 and Comparative Examples 1-3 to 1-6

Ferrite thin film-forming compositions were prepared in the same manner as Example 1-1 or 1-2, except that the ratios of amounts of the respective metal materials were adjusted such that the formed ferrite thin film had the composition shown in Table 1 below. Using these ferrite thin-film-forming compositions, NiZn ferrite thin films having the thicknesses shown in Table 1 were formed.

### Example 2-1

First, copper (II) nitrate trihydrate, zinc (II) nitrate tetrahydrate, and iron (III) nitrate nonahydrate were prepared as the metal materials. These materials were weighed such that the composition of the formed ferrite thin film became (Cu_{0.40}Zn_{0.60}O)_{1.0}(Fe₂O₃)_{1.0}. In addition, as the solvent, N-methyl pyrrolidone was prepared in an amount of 30 mass % with respect to 100 mass % of the prepared composition. As other solvents, propylene glycol was prepared in an amount of 10 mass % with respect to 100 mass % of the prepared composition. These solvents were added to the metal materials, and then the mixture was stirred in an oil bath at a temperature of 30° C. for 6 hours.

After stirring, as other solvents, 42.5 mass % of ethanol with respect to 100 mass % of the prepared composition was added to the solution such that the total amount of the metal materials in the composition became 4 mass % in terms of metal oxides. Next, the obtained solution was further stirred at room temperature for 24 hours. As a result, a ferrite thin film-forming composition was prepared.

Next, the prepared ferrite thin film-forming composition was subjected to spin coating at a rotating speed of 3000 rpm for 15 seconds. As a result, a coating film was formed on a silicon substrate on which a SiO₂ film was formed, and then the coating film was pre-baked at a temperature of 400° C. for S minutes. The processes from coating to pre-baking were repeated 5 times in total. As a result, an amorphous pre-baked film having the thickness shown in Table 2 was formed.

Finally, this film-formed substrate was baked at 700° C. by RTA. As a result, a CuZn ferrite thin film having the composition of (Cu_{0.40}Zn_{0.60}O)_{1.0}(Fe₂O₃)_{1.0} and the thickness shown in Table 2 was formed.

### Examples 2-2 and 2-3 and Comparative Examples 2-1 and 2-2

Ferrite thin film-forming compositions were prepared in the same manner as Example 2-1, except that the ratio of an amount of N-methyl pyrrolidone to 100 mass % of the total amount of the prepared composition was adjusted to the value shown in Table 2 below. Using these ferrite thin-film-forming compositions, CuZn ferrite thin films having the thicknesses shown in Table 2 were formed.

### Examples 2-4 to 2-9 and Comparative Examples 2-3 to 2-6

Ferrite thin film-forming compositions were prepared in the same manner as Example 2-1 or 2-2, except that the ratios of amounts of the respective metal materials were adjusted such that the formed ferrite thin film had the composition shown in fable 2 below. Using these ferrite thin-film-forming compositions, CuZn ferrite thin films having the thicknesses shown in Table 2 were formed.

### Example 3-1

First, nickel (II) acetate tetrahydrate, copper (II) nitrate trihydrate, zinc (II) nitrate tetrahydrate, and iron (III) nitrate nonahydrate were prepared as the metal materials. These materials were weighed such that the composition of the formed ferrite thin film became (Ni_{0.40}Cu_{0.20}O)_{1.0}(Fe₂O₃)_{1.0}. In addition, as the solvent, N-methyl pyrrolidone was prepared in an amount of 40 mass % with respect to 100 mass % of the prepared composition. In addition, propylene glycol was prepared in an amount of 15 mass % with respect to 100 mass % of the prepared composition. These solvents were added to the metal materials, and then the mixture was stirred in an oil bath at a temperature of 30° C. for 6 hours.

After stirring, as other solvents, 22.4 mass % of butanol with respect to 100 mass % of the prepared composition was added to the solution such that the total amount of the metal materials in the composition became 5 mass % in terms of metal oxides. Next, the obtained solution was further stirred at room temperature for 24 hours. As a result, a ferrite thin film-forming composition was prepared.

Next, the prepared ferrite thin film-forming composition was subjected to spin coating at a rotating speed of 3000 rpm for 15 seconds. As a result, a coating film was formed on a silicon substrate on which a SiO₂ film was formed, and then the coating film was pre-baked at a temperature of 400° C. for 5 minutes. The processes from coating to pre-baking were repeated 5 times in total. As a result, an amorphous pre-baked film having the thickness shown in Table 3 was formed.

Finally, this film-formed substrate was baked at 700° C. by RTA. As a result, a NiCuZn ferrite thin film having the composition of (Ni_{0.40}Cu_{0.20}Zn_{0.40}O)_{1.0}(Fe₂O₃)_{1.0} and the thickness shown in Table 3 was formed.

### Examples 3-2 and 3-3

Ferrite thin film-forming compositions were prepared in the same manner as Example 3-1, except that the ratio of an amount of N-methyl pyrrolidone to 100 mass % of the total amount of the prepared composition was adjusted to the value shown in Table 3 below. Using these ferrite thin-film-forming compositions, NiCuZn ferrite thin films having the thicknesses shown in Table 3 were formed.

### Comparative Example 3-1

First, nickel (II) nitrate hexahydrate, copper (II) nitrate trihydrate, zinc (II) nitrate tetrahydrate, and iron (III) nitrate nonahydrate were prepared as the metal materials. These materials were weighed such that the composition of the formed ferrite thin film became (Ni_{0.40}Cu_{0.20}Zn_{0.40}O)_{1.0}(Fe₂O₃)_{1.0}. In addition, N-N-dimethyl formamide was prepared as the solvent. This solvent was added to the metal materials, and then the mixture was stirred in an oil bath for 2 hours.

After stirring, as a stabilizer, acetic acid was added to the solution such that the total amount of the metal materials in the composition became 5 mass % in terms of metal oxides. Next, polyvinyl pyrrolidone (average molar weight: 40000) was added to the solution in an amount of 50 mol % with respect to the total amount of the metal materials in terms of metal oxides, and then the solution was stirred at room temperature for 24 hours. As a result, a ferrite thin film-forming composition was prepared.

In addition, using the prepared ferrite thin film-forming composition, a NiCuZn ferrite thin film having the thickness shown in Table 3 was formed in the same manner as Example 3-1.

### Comparative Examples 3-2 and 3-3

Ferrite thin film-forming compositions were prepared in the same manner as Example 3-1, except that the ratio of an amount of N-methyl pyrrolidone to 100 mass % of the total amount of the prepared composition was adjusted to the value shown in Table 3 below. Using these ferrite thin-film-forming compositions. NiCuZn ferrite thin films having the thicknesses shown in Table 3 were formed.

### Examples 3-4 to 3-8 and Comparative Examples 3-4 to 3-7

Ferrite thin film-forming compositions were prepared in the same manner as Example 3-1 or 3-2, except that the ratios of amounts of the respective metal materials were adjusted such that the formed ferrite thin film had the composition shown in Table 1 below. Using these ferrite thin-film-forming compositions, NiCuZn ferrite thin films having the thicknesses shown in Table 3 were formed.

### <Comparison Test and Evaluation>

With regard to each of the ferrite thin films obtained in Examples and Comparative Examples, the thickness and the initial magnetic permeability were measured using the following methods. In addition, the storage stability of each of the prepared ferrite thin film-forming compositions was evaluated. The results are shown in Tables 1 to 3 below.

(1) Film thickness: The thickness of a cross-section of the formed thin film was measured using a scanning microscope (trade name: s-4300, manufactured by Hitachi Ltd.). The thickness of the pre-baked film before baking was measured using the same method and the same device.

(2) Initial magnetic permeability: The initial magnetic permeability was measured at a frequency of about 40 MHz using an absolute permeability measuring device (impedance analyzer, trade name: HP4194A, manufactured by Agilent Technologies) and an air core coil formed of copper wire. The air core coil was formed as follows. An external shape was formed using a thin plate of an acrylic resin or the like in a size so as to precisely accommodate a wafer having a size of 1 cm×5 cm. Next, copper wire was wound around this external shape 20 to 80 times; and thereby, the air core coil was formed. The inductance of the prepared air core coil was measured using the impedance analyzer, and then the impedance was measured again after inserting a ferrite thin film-formed substrate having a size of 1 cm×5 cm as the core into the air core coil. At this time, since a difference ΔL between the impedances before and after the insertion of the core was obtained from the following expression (1), the initial magnetic permeability of the ferrite thin film was able to be calculated.

ΔL=μ₀×μ′×S×N²/l (1)

In the above formula (1), μ₀ represents the vacuum magnetic permeability, μ′ represents the actual part (initial magnetic permeability) in the complex magnetic permeability of the ferrite thin film, S represents the cross-sectional area of the ferrite thin film, N represents the winding number of the coil, and l represents the length of the coil.

(3) Storage Stability: The prepared ferrite thin film-forming composition was refrigerated at a temperature of 5° C. for 1 month, and then whether or not precipitation occurred in the composition was investigated by visual inspection. In Tables 1 to 3, “Unsatisfactory” represents the case where precipitation occurred in the refrigerated ferrite thin film-forming composition, and “Satisfactory” represents the case where precipitation did not occur in the refrigerated ferrite thin film-forming composition.

TABLE 1

| | Ratio of | | | | | | | |
|---|---|---|---|---|---|---|---|---|
| | N-Methyl | Composition | | | Thickness of | Thickness of | Initial | |
| | Pyrrolidone | (NiZn Ferrite) | | | Pre-Baked | Ferrite Thin | Magnetic | Storage |
| | (mass %) | t | s | x | Film (nm) | Film (nm) | Permeability | Stability |
| Example 1-1 | 30 | 1.0 | 1.0 | 0.36 | 600 | 410 | 11 | Satisfactory |
| Example 1-2 | 50 | 1.0 | 1.0 | 0.36 | 600 | 350 | 10 | Satisfactory |
| Example 1-3 | 60 | 1.0 | 1.0 | 0.36 | 600 | 310 | 11 | Satisfactory |
| Example 1-4 | 50 | 1.0 | 1.0 | 0.10 | 600 | 340 | 10 | Satisfactory |
| Example 1-5 | 50 | 1.0 | 1.0 | 0.65 | 600 | 340 | 12 | Satisfactory |
| Example 1-6 | 50 | 1.0 | 1.0 | 0.08 | 600 | 340 | 11 | Satisfactory |
| Example 1-7 | 50 | 1.0 | 1.0 | 0.67 | 600 | 340 | 11 | Satisfactory |
| Example 1-8 | 50 | 0.95 | 1.05 | 0.36 | 600 | 340 | 8 | Satisfactory |
| Example 1-9 | 50 | 1.05 | 0.95 | 0.36 | 600 | 340 | 8 | Satisfactory |
| Comparative Example 1-1 | 27 | 1.0 | 1.0 | 0.36 | 600 | 430 | 6 | Unsatisfactory |
| Comparative Example 1-2 | 65 | 1.0 | 1.0 | 0.36 | 600 | 370 | 5 | Satisfactory |
| Comparative Example 1-3 | 30 | 0.60 | 1.40 | 0.36 | 600 | 410 | 2 | Satisfactory |
| Comparative Example 1-4 | 30 | 1.40 | 0.60 | 0.36 | 600 | 410 | 2 | Satisfactory |
| Comparative Example 1-5 | 50 | 0.93 | 1.07 | 0.36 | 600 | 340 | 5 | Satisfactory |
| Comparative Example 1-6 | 50 | 1.07 | 0.93 | 0.36 | 600 | 340 | 4 | Satisfactory |

As clearly seen from Table 1, the initial magnetic permeability of the ferrite thin film obtained in Example 1-1 was high at 11.

In addition, when Examples 1-1, 1-2, and 1-3 were compared to Comparative Examples 1-1, the following results were obtained. In the ferrite thin film-forming composition prepared in Comparative Example 1-1 in which the amount ratio of N-methyl pyrrolidone was lower than 30 mass %, the solution was red and uniform immediately after the preparation; however, after 1 month of the refrigeration storage, green precipitates were observed in the composition; and therefore, the storage stability was poor. On the other hand, in the ferrite thin film-forming compositions prepared in Examples 1-1, 1-2, and 1-3, it was found that, even after 1 month of the refrigeration storage, precipitates were not observed in the compositions; and therefore, the storage stability was superior.

In Comparative Example 1-2 in which the amount ratio of N-methyl pyrrolidone was higher than 60 mass %, the storage stability was satisfactory; however, there was a problem in that film non-uniformity occurred.

In addition, when Examples 1-1 to 1-3, 1-8, and 1-9 were compared to Comparative Examples 1-3 to 1-6, the following results were obtained. In Comparative Examples 1-3 and 1-4 in which s and t did not satisfy 0.95≦s≦1.05 and 0.9≦t≦1.05, respectively, and s and t did not satisfy s+t=2 in the compositions of the obtained ferrite thin films, that is, in the formula (Ni₁₋ₓZnₓO)ₜ(Fe₂O₃)ₛ, both of the initial magnetic permeability values were 2 which was considerably low. In addition, in Comparative Examples 1-5 and 1-6, the initial magnetic permeability values were 5 and 4, respectively which were low. On the other hand, in Examples 1-1, 1-2, and 1-3 in which s and t satisfied the above-described requirements, the initial magnetic permeability values were 11, 10 and 11, respectively which were considerably high. In addition, in Examples 1-8 and 1-9, both of the respective initial magnetic permeability values were 8 which was considerably high. It was found from the above results that it is effective that the composition of the NiZn ferrite thin film be adjusted such that s and t satisfy 0.95≦s≦1.05 and 0.95≦t≦1.05, respectively, and s and t also satisfy s+t-2.

In addition, when Examples 1-4, 1-5, 1-6, and 1-7 were compared to each other, the following results were obtained. In Examples 1-4 and 1-5 in which x was in the range of 0.10≦x≦0.65, the initial magnetic permeability values were higher than those of Examples 1-6 and 1-7 in which x was out of the range. It was found from the above results that it is preferable that the composition of the NiZn ferrite thin film be adjusted such that x is in the range of 0.10≦x≦0.65.

TABLE 2

| | Ratio of | | | | | | | |
|---|---|---|---|---|---|---|---|---|
| | N-Methyl | Composition | | | Thickness of | Thickness of | Initial | |
| | Pyrrolidone | (CuZn Ferrite) | | | Pre-Baked | Ferrite Thin | Magnetic | Storage |
| | (mass %) | t | s | x | Film (nm) | Film (nm) | Permeability | Stability |
| Example 2-1 | 30 | 1.0 | 1.0 | 0.60 | 600 | 410 | 9 | Satisfactory |
| Example 2-2 | 50 | 1.0 | 1.0 | 0.60 | 600 | 350 | 9 | Satisfactory |
| Example 2-3 | 60 | 1.0 | 1.0 | 0.60 | 600 | 310 | 8 | Satisfactory |
| Example 2-4 | 50 | 1.0 | 1.0 | 0.20 | 600 | 340 | 8 | Satisfactory |
| Example 2-5 | 50 | 1.0 | 1.0 | 0.80 | 600 | 340 | 8 | Satisfactory |
| Example 2-6 | 50 | 1.0 | 1.0 | 0.18 | 600 | 340 | 7 | Satisfactory |
| Example 2-7 | 50 | 1.0 | 1.0 | 0.82 | 600 | 340 | 9 | Satisfactory |
| Example 2-8 | 50 | 0.95 | 1.05 | 0.36 | 600 | 340 | 10 | Satisfactory |
| Example 2-9 | 50 | 1.05 | 0.95 | 0.36 | 600 | 340 | 8 | Satisfactory |
| Comparative Example 2-1 | 27 | 1.0 | 1.0 | 0.60 | 600 | 430 | 5 | Unsatisfactory |
| Comparative Example 2-2 | 65 | 1.0 | 1.0 | 0.60 | 600 | 370 | 4 | Satisfactory |
| Comparative Example 2-3 | 30 | 0.60 | 1.40 | 0.60 | 600 | 410 | 2 | Satisfactory |
| Comparative Example 2-4 | 30 | 1.40 | 0.60 | 0.60 | 600 | 410 | 2 | Satisfactory |
| Comparative Example 2-5 | 50 | 0.93 | 1.07 | 0.60 | 600 | 340 | 3 | Satisfactory |
| Comparative Example 2-6 | 50 | 1.07 | 0.93 | 0.60 | 600 | 340 | 4 | Satisfactory |

As clearly seen from Table 2, the initial magnetic permeability value of the ferrite thin film obtained in Example 2-1 was 9 which was high.

In addition, when Examples 2-1, 2-2, and 2-3 were compared to Comparative Examples 2-1, the following results were obtained. In the ferrite thin film-forming composition prepared in Comparative Example 2-1 in which the amount ratio of N-methyl pyrrolidone was lower than 30 mass %, the solution was red and uniform immediately after the preparation; however, after 1 month of the refrigeration storage, green precipitates were observed in the composition, and the storage stability was poor. On the other hand, in the ferrite thin film-forming compositions prepared in Examples 2-1, 2-2, and 2-3, it was found that, even after 1 month of the refrigeration storage, precipitates were not observed in the composition, and the storage stability was superior.

In Comparative Example 2-2 in which the amount ratio of N-methyl pyrrolidone was higher than 60 mass %, the storage stability was satisfactory; however, there was a problem in that film non-uniformity occurred.

In addition, when Examples 2-1 to 2-3, 2-8, and 2-9 were compared to Comparative Examples 2-3 to 2-6, the following results were obtained. In Comparative Examples 2-3 to 2-6 in which s and t did not satisfy 0.95≦s≦1.05 and 0.95≦t≦1.05, respectively, and s and t did not satisfy s+t=2 in the compositions of the obtained ferrite thin films, that is, in the formula (Cu₁₋ₓZnₓO)ₜ(Fe₂O₃)ₛ, the initial magnetic permeability values were in a range of 2 to 4 which were considerably low. On the other hand, in Examples 2-1, 2-2, and 2-3 in which s and t satisfied the above-described requirements, the initial magnetic permeability values were 9, 9 and 8, respectively which were considerably high. In addition, in Examples 2-8 and 2-9, the initial magnetic permeability values were 10 and 8, respectively which were high. It was found from the above results that it is effective that the composition of the CuZn ferrite thin film be adjusted such that s and t satisfy 0.95≦s≦1.05 and 0.95≦t≦1.05, respectively, and s and t satisfy s+t=2.

In addition, when Examples 2-4, 2-5, 2-6, and 2-7 were compared to each other, the following results were obtained. In Examples 2-4 and 2-5 in which x was in the range of 0.20≦x≦0.80, the initial magnetic permeability values were higher than or equal to those of Examples 2-6 and 2-7 in which x was out of the range. It was found from the above results that it is preferable that the composition of the CuZn ferrite thin film be adjusted such that x is in the range of 0.20≦x≦0.80.

TABLE 3

| | Ratio of | | | | | | | |
|---|---|---|---|---|---|---|---|---|
| | N-Methyl | Composition | | | Thickness of | Thickness of | Initial | |
| | Pyrrolidone | (NiCuZn Ferrite) | | | Pre-Baked | Ferrite Thin | Magnetic | Storage |
| | (mass %) | t | s | y | Film (nm) | Film (nm) | Permeability | Stability |
| Example 3-1 | 30 | 1.0 | 1.0 | 0.40 | 600 | 410 | 11 | Satisfactory |
| Example 3-2 | 50 | 1.0 | 1.0 | 0.40 | 600 | 350 | 10 | Satisfactory |
| Example 3-3 | 60 | 1.0 | 1.0 | 0.40 | 600 | 310 | 10 | Satisfactory |
| Example 3-4 | 50 | 1.0 | 1.0 | 0.20 | 600 | 340 | 12 | Satisfactory |
| Example 3-5 | 50 | 1.0 | 1.0 | 0.18 | 600 | 340 | 9 | Satisfactory |
| Example 3-6 | 50 | 1.0 | 1.0 | 0.42 | 600 | 340 | 8 | Satisfactory |
| Example 3-7 | 50 | 0.95 | 1.05 | 0.40 | 600 | 340 | 9 | Satisfactory |
| Example 3-8 | 50 | 1.05 | 0.95 | 0.40 | 600 | 340 | 12 | Satisfactory |
| Comparative Example 3-1 | — | 1.0 | 1.0 | 0.40 | 600 | 420 | 5 | Unsatisfactory |
| Comparative Example 3-2 | 27 | 1.0 | 1.0 | 0.40 | 600 | 370 | 4 | Unsatisfactory |
| Comparative Example 3-3 | 65 | 1.0 | 1.0 | 0.40 | 600 | 400 | 6 | Satisfactory |
| Comparative Example 3-4 | 30 | 0.60 | 1.40 | 0.40 | 600 | 410 | 2 | Satisfactory |
| Comparative Example 3-5 | 30 | 1.40 | 0.60 | 0.40 | 600 | 390 | 2 | Satisfactory |
| Comparative Example 3-6 | 50 | 0.93 | 1.07 | 0.40 | 600 | 340 | 3 | Satisfactory |
| Comparative Example 3-7 | 50 | 1.07 | 0.93 | 0.40 | 600 | 340 | 2 | Satisfactory |

As clearly seen from Table 3, when Examples 3-1, 3-2, and 3-3 were compared to Comparative Example 3-1, the following results were obtained. In the ferrite thin film obtained in Comparative Example-3-1 and not containing N-methyl pyrrolidone, the initial magnetic permeability value was 5 because the film density was low. On the other hand, in the ferrite thin films obtained in Examples 3-1, 3-2, and 3-3, the initial magnetic permeability values were 11, 10, and 10, respectively which were high.

In addition, when Examples 3-1, 3-2, and 3-3 were compared to Comparative Examples 3-1, 3-2, and 3-3, the following results were obtained. In the ferrite thin film-forming composition prepared in Comparative Example 3-1 and not containing N-methyl pyrrolidone and in the ferrite thin film-forming composition prepared in Comparative Example 3-2 in which the amount ratio of N-methyl pyrrolidone was lower than 30 mass %, the solutions were red and uniform immediately after the preparation; however, after 1 month of the refrigeration storage, green precipitates were observed in the compositions, and the storage stability was poor. In addition, in Comparative Example 3-3 in which the amount ratio of N-methyl pyrrolidone was higher than 60 mass %, the storage stability was satisfactory; however, there was a problem in that film non-uniformity occurred. On the other hand, in the ferrite thin film-forming compositions prepared in Examples 3-1, 3-2, and 3-3, it was found that, even after 1 month of the refrigeration storage, precipitates were not observed in the compositions, and the storage stability was superior.

In addition, when Examples 3-1 to 3-3, 3-7, and 3-8 were compared to Comparative Examples 3-4 to 3-7, the following results were obtained. In Comparative Examples 3-4 to 3-7 in which s and t did not satisfy 0.95≦s≦1.05 and 0.95≦t≦1.05, respectively, and s and t did not satisfy s+t=2 in the compositions of the obtained ferrite thin films, that is, in the formula (Ni_{0.80-y}Cu_{0.20}Zn_{y}O)ₜ(Fe₂O₃)ₛ, the initial magnetic permeability values were s in a range of 2 to 3 which were considerably low. On the other hand, in Examples 3-1, 3-2, and 3-3 in which s and t satisfied the above-described requirements, the initial magnetic permeability values were s 11, 10 and 10, respectively which were considerably high. In addition, in Examples 3-7 and 3-8, the initial magnetic permeability values were 9 and 12, respectively which were considerably high. It was found from the above results that it is effective that the composition of the NiCuZn ferrite thin film be adjusted such that s and t satisfy 0.95≦s≦1.05 and 0.95≦t≦1.05, respectively, and s and t satisfy s+t=2.

In addition, when Examples 3-2, 3-4, 3-5, and 3-6 were compared to each other, the following results were obtained. In Examples 3-2 and 3-4 in which y was in the range of 0.20≦y≦0.40, the initial magnetic permeability values were higher than those of Examples 3-5 and 3-6 in which y was out of the range. It was found from the above results that it is preferable that the composition of the NiCuZn ferrite thin film be adjusted such that y is in the range of 0.20≦y≦0.40.

While preferred embodiments of the invention have been described and illustrated above, it should be understood that these are exemplary of the invention and are not to be considered as limiting. Additions, omissions, substitutions, and other modifications can be made without departing from the features of the present invention. Accordingly, the invention is not to be considered as being limited by the foregoing description, and is only limited by the scope of the claims.

### INDUSTRIAL APPLICABILITY

The ferrite thin film-forming composition according to the invention can be desirably used for forming a magnetic film or the like of a thin film inductor which is incorporated into an integrated passive device (IPD) chip.

1. A ferrite thin film-forming composition for forming a ferrite thin film having a composition, which is represented by (Ni₁₋ₓZnₓO)ₜ(Fe₂O₃), (Cu₁₋ₓZnₓO)ₜ(Fe₂O₃)ₛ, or (Ni_{0.80-y}Cu_{0.20}Zn_{y}O)ₜ(Fe₂O₃)ₛ (wherein x satisfies 0<x<1; y satisfies 0<y<0.80; and s and t satisfy 0.95≦s≦1.05 and 0.95≦t≦1.05, respectively, and s and t also satisfy s+t=2), using a sol-gel method, the composition comprising:
metal raw materials; and
a solvent containing N-methyl pyrrolidone,
wherein a ratio of an amount of N-methyl pyrrolidone to 100 mass % of the total amount of the composition is in a range of 30 to 60 mass %.

2. The ferrite thin film-forming composition according to claim 1,
wherein the metal raw materials are metal alkoxides, acetates, a naphthenates, or nitrates which include Ni, Zn, Cu, or Fe.

3. The ferrite thin film-forming composition according to claim 1,
wherein in the ferrite thin film having the composition represented by (Ni₁₋ₓZnₓO)ₜ(Fe₂O₃)ₛ, x is in a range of 0.10≦x≦0.65.

4. The ferrite thin film-forming composition according to claim 1,
wherein in the ferrite thin film having the composition represented by (Cu₁₋ₓZnₓO)ₜ(Fe₂O₃)ₛ, x is in a range of 0.20≦x≦0.80.

5. The ferrite thin film-forming composition according to claim 1,
wherein in the ferrite thin film having the composition represented by (Ni_{0.80-y}Cu_{0.20}Zn_{y}O)ₜ(Fe₂O₃)ₛ, y is in a range of 0.20≦x≦0.40.

6. A method of forming a ferrite thin film, the method comprising:
forming a film with a sol-gel method using the ferrite thin film-forming composition according to claim 1.

7. The ferrite thin film-forming composition according to claim 2,
wherein in the ferrite thin film having the composition represented by (Ni₁₋ₓZnₓO)ₜ(Fe₂O₃)ₛ, x is in a range of 0.10≦x≦0.65.

8. The ferrite thin film-forming composition according to claim 2,
wherein in the ferrite thin film having the composition represented by (Cu₁₋ₓZnₓO)ₜ(Fe₂O₃)ₛ, x is in a range of 0.20≦x≦0.80.

9. The ferrite thin film-forming composition according to claim 2,
wherein in the ferrite thin film having the composition represented by (Ni_{0.80-y}Cu_{0.20}Zn_{y}O)ₜ(Fe₂O₃)ₛ, y is in a range of 0.20≦x≦0.40.

10. A method of forming a ferrite thin film, the method comprising:
forming a film with a sol-gel method using the ferrite thin film-forming composition according to claim 2.

11. A method of forming a ferrite thin film, the method comprising:
forming a film with a sol-gel method using the ferrite thin film-forming composition according to claim 3.

12. A method of forming a ferrite thin film, the method comprising:
forming a film with a sol-gel method using the ferrite thin film-forming composition according to claim 4.

13. A method of forming a ferrite thin film, the method comprising:
forming a film with a sol-gel method using the ferrite thin film-forming composition according to claim 5.

14. A method of forming a ferrite thin film, the method comprising:
forming a film with a sol-gel method using the ferrite thin film-forming composition according to claim 7.

15. A method of forming a ferrite thin film, the method comprising:
forming a film with a sol-gel method using the ferrite thin film-forming composition according to claim 8.

16. A method of forming a ferrite thin film, the method comprising:
forming a film with a sol-gel method using the ferrite thin film-forming composition according to claim 9.
